(19) United States
(12) Patent Application Publication
(10) Pub. No.: US 2026/0145673 A1
(43) Pub. Date: May 28, 2026

(54) VEHICLE POSITIONING METHOD BASED ON WEIGHT ADJUSTMENT AND SYSTEM USING THE SAME

(71) Applicant: Automotive Research & Testing Center, Changhua County (TW)

(72) Inventors: Nong-Hong LIN, Changhua County (TW); You-Sian LIN, Changhua County (TW)

(73) Assignee: Automotive Research & Testing Center, Changhua County (TW)

(21) Appl. No.: 18/957,225

(22) Filed: Nov. 22, 2024

(51) Int. Cl. B60W 30/12; B60W 10/30; B60W 50/00; B60W 50/02

(52) U.S. Cl. CPC B60W 30/12; B60W 10/30; B60W 50/0205; B60W 2050/0086; B60W 2420/403; B60W 2556/10; B60W 2556/20; B60W 2556/50; B60W 2756/00

(57) ABSTRACT

In a vehicle positioning method based on weight adjustment performed by a positioning system arranged on a vehicle, the positioning system generates an image quality value and a lane line confidence and generates an image confidence based on the image quality value and the lane line confidence. The positioning system generates a positioning confidence based on a plurality of positioning data that are received. The positioning system adjusts a driving image weight value, a positioning data weight value, and an inertial data weight value based on the image confidence and the positioning confidence. The positioning system adjusts an original positioning coordinate value that is obtained by the positioning system based on the driving image weight value, the positioning data weight value, and the inertial data weight value to generate a final positioning coordinate value.

### BACKGROUND OF THE INVENTION

### Field of the Invention

The present invention relates to a vehicle positioning method based on weight adjustment and a system using the same, particularly to a vehicle positioning method based on weight adjustment and a system using the same that generate a positioning coordinate value by adjusting a driving image weight value, a positioning data weight value, and an inertial data weight value.

### Description of the Related Art

In recent years, autonomous driving has been a technical field that major vehicle manufacturers are competing to develop. With the vigorous development of artificial intelligence and hardware technology, it is an inevitable trend that all major transportation tools will be gradually replaced by autonomous vehicles in the future. The positioning method is the crucial technology in the field of autonomous driving. Among the many conventional technologies, one uses multiple cameras as the main perception, combined with artificial intelligence deep learning, to detect the surrounding environment and road markings to achieve driving assistance such as traffic sensing, cruise positioning, lane changing, and automatic parking. However, over-reliance on cameras may cause the driving image to be unable to show both dark and bright details when encountering excessive light contrast in and out of tunnels, or when encountering road sections with excessive wear and tear of road markings. These are all problems. It is easy to cause failure or abnormality in positioning determination based on driving images. In addition, in winter or rainy days, due to the large temperature difference between the inside and outside of the objective lens of the camera lens, water vapor condenses on the outer surface of the objective lens to causing the lens to fog up. Alternatively, rainwater splashes onto the outer surface of the objective lens of the camera lens, such that some areas of the captured driving image are blurred. These situations will also cause the positioning determination based on the driving image to be invalid or abnormal. Another common technology is LiDAR (Light Detection And Ranging) that combines multiple cameras and multiple different ranging ranges. The driving images captured by the camera can determine the feature points of the lane lines. LiDAR can reach centimeter-level accuracy. The feature points are matched with the vector map, such that the vehicle's location can indeed be accurately positioned on the vector map. However, although the optical radar is highly accurate, its cost is too high. It is difficult for vehicle manufacturers to reduce manufacturing costs. Thus, the selling price cannot be naturally reduced, thus affecting the popularity of autonomous vehicles.

Accordingly, the inventor has developed a design that is easy to assemble and install to avoid the foregoing shortcomings. The design has the advantages of low cost, taking into account considerations such as flexibility of use and economy. As a result, the present invention is produced.

### SUMMARY OF THE INVENTION

The technical problem to be solved by the present invention is that how to adjust a driving image weight value and other sensing and measuring data weight values combined with other sensing and measuring data for temporary reinforcement to generate a final positioning coordinate value when driving images are abnormal. This can eliminate the need to use high-priced optical radar and avoid over-reliance on driving images that may cause failure or abnormality of positioning determination.

In order to solve the foregoing problems and achieve the desired objectives, the present invention provides a vehicle positioning system based on weight adjustment arranged on a vehicle. The vehicle positioning system includes an image quality module, a lane line confidence module, an image confidence module, a positioning confidence module, a weight adjusting module, and a positioning adjusting module. The image quality module is configured to generate an image quality value based on the exposure concentration of each of a plurality of driving images captured by a plurality of image capturing modules arranged on the vehicle. The lane line confidence module is configured to generate a lane line confidence based on the plurality of driving images. The image confidence module is configured to generate an image confidence based on the image quality value and the lane line confidence. The positioning confidence module is configured to generate a positioning confidence based on a plurality of positioning data received by a positioning sensing module arranged on the vehicle. The weight adjusting module is configured to adjust a driving image weight value, a positioning data weight value, and an inertial data weight value based on the image confidence and the positioning confidence. The positioning adjusting module is configured to adjust an original positioning coordinate value obtained by the positioning system based on the driving image weight value, the positioning data weight value, and the inertial data weight value to generate a final positioning coordinate value. The driving image weight value and other sensing and measuring data weight values combined with other sensing and measuring data for temporary reinforcement are adjusted to generate the final positioning coordinate value when driving images are abnormal. This can eliminate the need to use high-priced optical radar and avoid over-reliance on driving images that may cause failure or abnormality of positioning determination.

Besides, the present invention further provides vehicle positioning method based on weight adjustment performed by a positioning system arranged on a vehicle. The vehicle positioning method includes: by an image quality module of the positioning system, generating an image quality value based on the exposure concentration of each of a plurality of driving images captured by a plurality of image capturing modules arranged on the vehicle; by a lane line confidence module of the positioning system, generating a lane line confidence based on the plurality of driving images; by an image confidence module of the positioning system, generating an image confidence based on the image quality value and the lane line confidence; by a positioning confidence module of the positioning system, generating a positioning confidence based on a plurality of positioning data received by a positioning sensing module arranged on the vehicle; by a weight adjusting module of the positioning system, adjusting a driving image weight value, a positioning data weight value, and an inertial data weight value based on the image confidence and the positioning confidence; and by a positioning adjusting module of the positioning system, adjusting an original positioning coordinate value based on the driving image weight value, the positioning data weight value, and the inertial data weight value to generate a final positioning coordinate value.

In implementations, the image quality module further generates the image quality value based on the exposure concentration and image clarity of each of the plurality of driving images captured by the plurality of image capturing modules.

In implementations, the image quality module decreases the image quality value when the exposure concentration is greater than a first threshold value or less than a second threshold value. The image quality module increases the image quality value when the exposure concentration is less than or equal to the first threshold value and the exposure concentration is greater than or equal to the second threshold value. The first threshold value is greater than the second threshold value.

In implementations, the plurality of positioning data include a plurality of satellite positioning data that respectively correspond to the plurality of positioning data. The positioning confidence module generates a dilution of precision based on the plurality of satellite positioning data, and then generates the positioning confidence based on the dilution of precision. The positioning sensing module receives the plurality of satellite positioning data transmitted by a plurality of positioning satellites that respectively correspond to the plurality of satellite positioning data. The dilution of precision is at least related to the number of the plurality of positioning satellites, the distribution positions of the plurality of positioning satellites relative to the vehicle, and the distances of the plurality of positioning satellites relative to the vehicle.

In implementations, the weight adjusting module adjusts the driving image weight value to 100% and adjusts the positioning data weight value and the inertial data weight value to 0 when the image confidence is greater than or equal to an image confidence threshold value. The weight adjusting module adjusts the driving image weight value to less than 100% and adjusts the positioning data weight value and the inertial data weight value to greater than 0 and less than the driving image weight value when the image confidence is less than an image confidence threshold value and the positioning confidence is greater than or equal to a positioning confidence threshold value. The weight adjusting module adjusts the driving image weight value to less than 100%, adjusts the positioning data weight value to 0, and adjusts the inertial data weight value to greater than 0 and less than the driving image weight value when the image confidence is less than an image confidence threshold value and the positioning confidence is less than a positioning confidence threshold value.

In implementations, the lane line confidence module detects a lane line feature point set of the plurality of driving images to generate a lane line feature point distribution, and analyzes lane continuity and lane line features based on the lane line feature point distribution to generate the lane line confidence.

In implementations, the step of using the positioning adjusting module to generate the final positioning coordinate value includes: by the positioning adjusting module, matching the lane line features with a vector map to generate a driving image coordinate value, wherein the vector map is stored in a storage module of the positioning system or obtained from a mapping module arranged in a cloud through a wireless receiving module arranged on the vehicle; when the positioning data weight value is not equal to 0, the positioning adjusting module generates a positioning data coordinate value based on the plurality of positioning data; when the inertial data weight value is not equal to 0, the positioning adjusting module generates an inertial data coordinate value based on the original positioning coordinate value and inertial measurement data measured by an inertial measurement module arranged on the vehicle; and by the positioning adjusting module, generating the final positioning coordinate value, wherein the final positioning coordinate value=[(the driving image coordinate value×the driving image weight value)+(the positioning data coordinate value×the positioning data weight value)+(the inertial data coordinate value×the inertial data weight value) and the inertial data weight value=(100%−¿the driving image weight value−¿the positioning data weight value)].

In implementations, when the positioning system never obtains the original positioning coordinate value, the positioning system initially obtains the original positioning coordinate value by performing following steps: by the positioning adjusting module, matching the lane line features with a vector map to generate a driving image coordinate value, wherein the vector map is stored in a storage module of the positioning system or obtained from a mapping module arranged in a cloud through a wireless receiving module arranged on the vehicle; and by the positioning adjusting module, copying a generated the driving image coordinate value to the original positioning coordinate value, so that the positioning system obtains the original positioning coordinate value having the driving image coordinate value.

In implementations, when the positioning system has obtained the original positioning coordinate value by previously performing the vehicle positioning method, the positioning adjusting module copies the final positioning coordinate value generated by presently performing the vehicle positioning method to the original positioning coordinate value.

In implementations, the positioning adjusting module remains to generate a positioning failure signal and the final positioning coordinate value when the image confidence remains less than an image confidence threshold value and the positioning confidence remains less than a positioning confidence threshold value within a time interval. The positioning adjusting module stops remaining to generate the positioning failure signal when the image confidence is greater than or equal to the image confidence threshold value or the positioning confidence is greater than or equal to the positioning confidence threshold value.

In implementations, the positioning adjusting module generate a warning signal when the image confidence remains less than an image confidence threshold value and the positioning confidence remains to greater than or equal to a positioning confidence threshold value within a time interval. The positioning adjusting module stops generating the warning signal when the image confidence is greater than or equal to the image confidence threshold value or the positioning confidence is less than the positioning confidence threshold value.

Below, the embodiments are described in detail in cooperation with the drawings to make easily understood the technical contents, features and accomplishments of the present invention.

### BRIEF DESCRIPTION OF THE DRAWINGS

FIG. 1 is a schematic diagram illustrating a vehicle positioning system according to an embodiment of the present invention;

FIG. 2 is a flowchart of a vehicle positioning method according to an embodiment of the present invention;

FIG. 3 is an exposure histogram of the present invention;

FIG. 4 is a schematic diagram illustrating the variation of a dilution of precision of the present invention over time;

FIGS. 5A and 5B are respectively schematic diagrams illustrating the variations of an image confidence and a positioning confidence of the present invention over time when a vehicle drives on a flat road;

FIGS. 6A and 6B are respectively schematic diagrams illustrating the variations of an image confidence and a positioning confidence of the present invention over time when a vehicle drives at a multi-fork intersection and under a viaduct;

FIGS. 7A and 7B are respectively schematic diagrams illustrating the variations of an image confidence and a positioning confidence of the present invention over time when a vehicle drives out of the entrance of a tunnel; and

FIGS. 8A and 8B are respectively schematic diagrams illustrating the variations of an image confidence and a positioning confidence of the present invention over time when a vehicle drives out of the entrance of another tunnel.

### DETAILED DESCRIPTION OF THE INVENTION

Reference will now be made in detail to embodiments illustrated in the accompanying drawings. Wherever possible, the same reference numbers are used in the drawings and the description to refer to the same or like parts. In the drawings, the shape and thickness may be exaggerated for clarity and convenience. This description will be directed in particular to elements forming part of, or cooperating more directly with, methods and apparatus in accordance with the present disclosure. It is to be understood that elements not specifically shown or described may take various forms well known to those skilled in the art. Many alternatives and modifications will be apparent to those skilled in the art, once informed by the present disclosure.

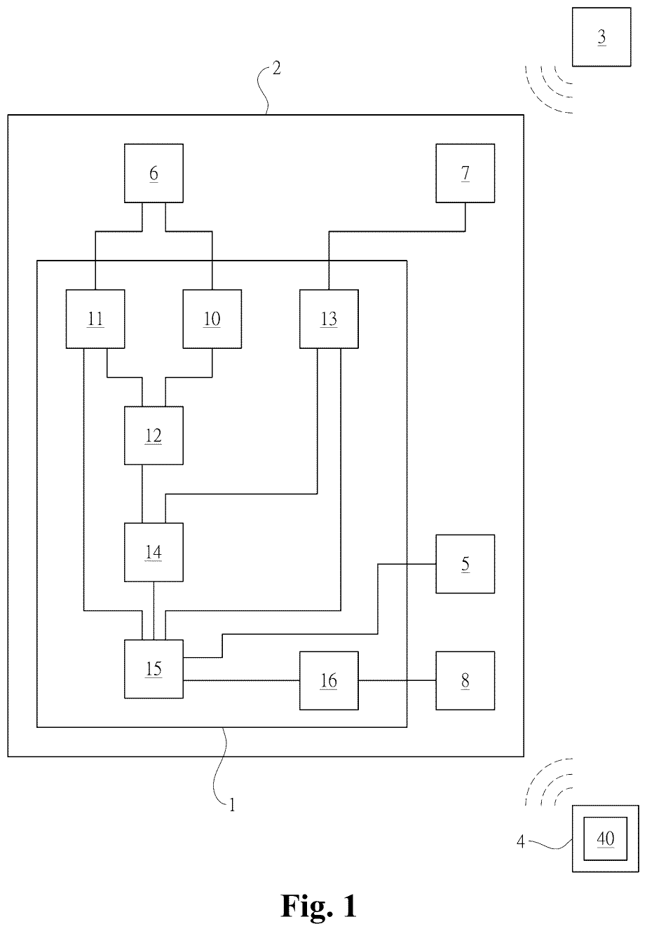

Please refer to FIG. 1. FIG. 1 is a schematic diagram illustrating a vehicle positioning system according to an embodiment of the present invention. The vehicle positioning system 1 based on weight adjustment of the present invention is arranged on a vehicle 2. The vehicle positioning system 1 includes an image quality module 10, a lane line confidence module 11, an image confidence module 12, a positioning confidence module 13, a weight adjusting module 14, a positioning adjusting module 15, and a storage module 16. The image quality module 10 is connected to a plurality of image capturing modules 6 arranged on the vehicle 2. The plurality of image capturing modules 6 can be cameras. The image capturing modules 6 are configured to capture driving images. The image quality module 10 is configured to receive the plurality of driving images captured by the plurality of image capturing modules 6, and generate an image quality value based on the exposure concentration and image clarity of each of the plurality of driving images. The lane line confidence module 11 is connected to the plurality of image capturing modules 6 for receiving the plurality of driving images captured by the plurality of image capturing modules 6 and generating a lane line confidence based on the plurality of driving images.

Furthermore, the image confidence module 12 is respectively connected to the image quality module 10 and the lane line confidence module 11 for receiving the image quality value generated by the image quality module 10 and the lane line confidence generated by the lane line confidence module 11. The image confidence module 12 generates an image confidence based on the image quality value and the lane line confidence. The positioning confidence module 13 is connected to a positioning sensing module 7 arranged on the vehicle 2 for receiving a plurality of positioning data received by the positioning sensing module 7 and generating a positioning confidence based on the plurality of positioning data. The weight adjusting module 14 is respectively connected to the image confidence module 12 and the positioning confidence module 13 for receiving the image confidence generated by the image confidence module 12 and the positioning confidence generated by the positioning confidence module 13 respectively. The weight adjusting module 14 adjusts a driving image weight value, a positioning data weight value, and an inertial data weight value based on the image confidence and the positioning confidence.

The positioning adjusting module 15 is respectively connected to the lane line confidence module 11, the weight adjusting module 14, the positioning confidence module 13, an inertial measurement module 15 arranged on the vehicle 2, and the storage module 16. The storage module 16 is connected to a wireless receiving module 8 arranged on the vehicle 2. The storage module 16 can be configured to pre-stores vector maps. Alternatively, the storage module 16 can obtain the vector map from a mapping module 40 arranged in a cloud 4 through a wireless receiving module 8 from time to time, and then store the vector map in the storage module 16 in advance. The storage module 16 can obtain the vector map from the mapping module 40 arranged in the cloud 4 through the wireless receiving module 8, and then transmit the vector map to the positioning adjusting module 15 (and simultaneously store the vector map in the storage module 16). The positioning adjusting module 15 is configured to receive the driving image weight value, the positioning data weight value, and the inertial data weight value adjusted by the weight adjusting module 14, and adjust an original positioning coordinate value obtained by the vehicle positioning system 1 based on the driving image weight value, the positioning data weight value, and the inertial data weight value to generate a final positioning coordinate value. The driving image weight value, the positioning data weight value, and the inertial data weight value combined with positioning data and inertial data for temporary reinforcement are adjusted to generate a final positioning coordinate value when driving images are abnormal. This can eliminate the need to use high-priced optical radar and avoid over-reliance on driving images that may cause failure or abnormality of positioning determination.

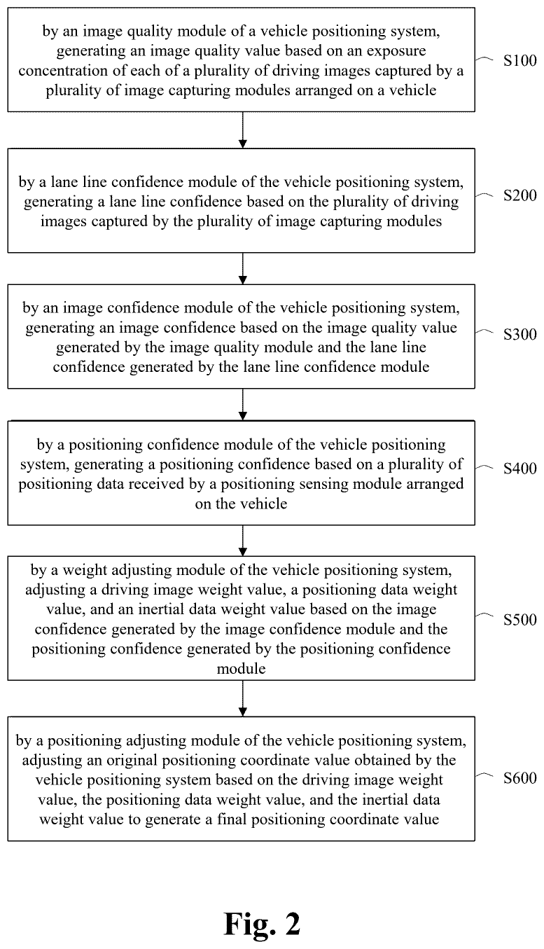

Besides, the present invention further provides a vehicle positioning method based on weight adjustment. Please refer to FIG. 2. FIG. 2 is a flowchart of a vehicle positioning method according to an embodiment of the present invention. The vehicle positioning method is performed by a vehicle positioning system 1 arranged on a vehicle 2. The vehicle positioning method includes:

Step 100: by an image quality module 10 of the vehicle positioning system 1, generating an image quality value based on an exposure concentration of each of a plurality of driving images captured by a plurality of image capturing modules 6 arranged on the vehicle 2;

Step 200: by a lane line confidence module 11 of the vehicle positioning system 1, generating a lane line confidence based on the plurality of driving images captured by the plurality of image capturing modules 6;

Step 300: by an image confidence module 12 of the vehicle positioning system 1, generating an image confidence based on the image quality value generated by the image quality module 10 and the lane line confidence generated by the lane line confidence module 11;

Step 400: by a positioning confidence module 13 of the vehicle positioning system 1, generating a positioning confidence based on a plurality of positioning data received by a positioning sensing module 7 arranged on the vehicle 2;

Step 500: by a weight adjusting module 14 of the vehicle positioning system 1, adjusting a driving image weight value, a positioning data weight value, and an inertial data weight value based on the image confidence generated by the image confidence module 12 and the positioning confidence generated by the positioning confidence module 13; and

Step 600: by a positioning adjusting module 15 of the vehicle positioning system 1, adjusting an original positioning coordinate value obtained by the vehicle positioning system 1 based on the driving image weight value, the positioning data weight value, and the inertial data weight value adjusted by the weight adjusting module 14 to generate a final positioning coordinate value.

In some embodiment, in Step 100, the image quality module 10 further generates the image quality value based on the exposure concentration of each of the plurality of driving images. The image quality module 10 decreases the image quality value when the exposure concentration is greater than a first threshold value or less than a second threshold value. The image quality module 10 increases the image quality value when the exposure concentration is less than or equal to the first threshold value and the exposure concentration is greater than or equal to the second threshold value. The first threshold value is greater than the second threshold value. That is to say, the image quality value generated by the image quality module 10 is affected by the exposure concentration of each driving image.

In general, the photosensitive element of the image capturing module 6 has its own dynamic range. In a single driving image captured by the image capturing module 6, the darkest and brightest ranges that can be distinguished by the image capturing module 6 will be limited by the dynamic range of the photosensitive element of the image capturing module 6. When capturing a driving image in a situation where the illumination contrast of an environment is too high, the driving image captured by the image capturing module 6 cannot simultaneously show the details of the dark parts and the details of the bright parts. That is to say, when the illumination contrast is too high and the captured driving image can clearly show the details of the dark parts, the bright parts will be overexposed (or called dead white), causing the details of the bright parts to be indistinguishable. On the contrary, when the captured driving image can clearly show the details of the bright parts, the dark parts will be underexposed (or called dead black), causing the details of the dark parts to be indistinguishable.

For example, when a vehicle prepares to enter a tunnel from its entrance and the sunlight outside the tunnel has sufficient intensity at this time, the light intensity in the tunnel will be very low (i.e., the illumination contrast is too high). Thus, the captured driving images will be underexposed for a short period of time. When the vehicle prepares to exit the tunnel entrance and there is sufficient sunlight outside the tunnel, the light intensity inside the tunnel will be very low (i.e., the illumination contrast is too high). Thus, the captured driving images are overexposed for a short period of time. For example of overexposure, when driving on a mountain road at night, the oncoming vehicle turns on its high beam, causing the image capturing module 6 to be directly illuminated by the high beam and causing the driving image to be overexposed. For another example of overexposure, when the sun is at a low angle and the vehicle drives toward the direction of the sun in the morning and dusk, it is easy to cause the driving image to be overexposed. For example of underexposure, the vehicle drives on a mountain road. When driving from a road illuminated by strong sunlight to an extremely dark road where the strong sunlight is blocked by the shadow of the mountain, it is easy to cause the driving image to be underexposed.

In the foregoing examples, when overexposed, the exposure concentration of the driving image is greater than the first threshold value. In such a case, the image quality module 10 decreases the image quality value. When underexposed, the exposure concentration of the driving image is less than the second threshold value. In such a case, the image quality module 10 decreases the image quality value. In other examples, if there is neither overexposure nor underexposure, the image quality module 10 will increase the image quality value.

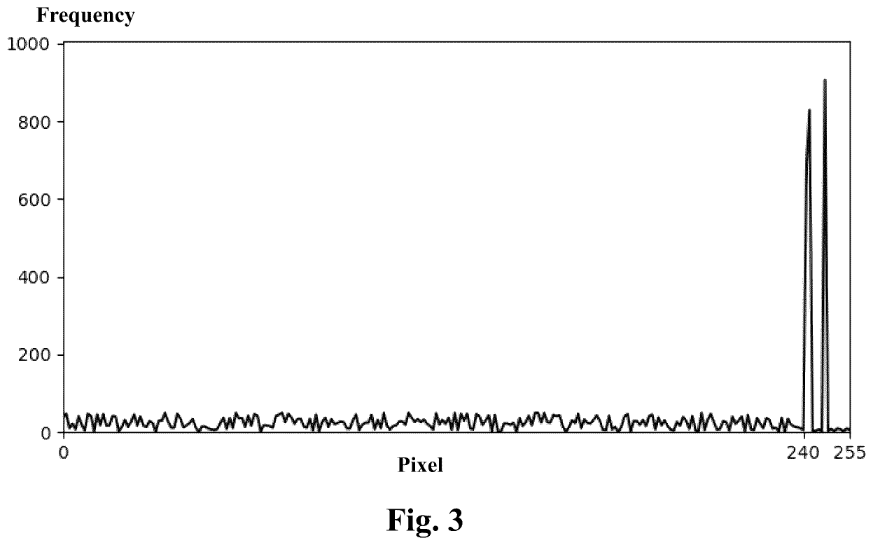

In a preferred embodiment, the image quality module 10 of the present invention can generate an exposure histogram of each of a plurality of driving images and determine the exposure concentration based on the exposure histogram. When the exposure concentration of the exposure histogram is excessively concentrated in a dark area, it means that the driving image is underexposed. When the exposure concentration of the exposure histogram is excessively concentrated in a bright area, it means that the driving image is overexposed. Please also refer to FIG. 3. FIG. 3 is an exposure histogram of the present invention. In FIG. 3, it can be seen from the exposure histogram of the driving image generated by the image quality module 10 that the exposure concentration is obviously concentrated in the bright area. That is to say, the driving image is overexposed. When the exposure concentration of the exposure histogram of the driving image is greater than the first threshold value, the image quality module 10 decreases the image quality value because the driving image is overexposed. When the exposure concentration of the exposure histogram of the driving image is less than the second threshold value, the image quality module 10 decreases the image quality value because the driving image is underexposed. When the exposure concentration of the exposure histogram is less than or equal to the first threshold value and greater than or equal to the second threshold value, the image quality module 10 increases the image quality value.

In some embodiments, the image quality module 10 of the present invention generates an image quality value based on the exposure concentration and the image clarity of a plurality of driving images. The image clarity of driving images will be affected by some factors. For example, on rainy days, rainwater may splash onto the outer surface of the objective lens of the lens of the image capturing module 6, blurring some areas of the captured driving image and affecting image clarity. Another situation that is often encountered in winter or rainy days is that when the temperature difference between the inside and outside of the objective lens of the image capturing module 6 is large, water vapor condenses on the outer surface of the objective lens, causing the lens to fog up. This will prevent the image capturing module 6 from capturing clear images. In the foregoing circumstances, when the exposure concentration of the driving image is determined individually, the high exposure concentration will not fall into an overexposed or underexposed area, but the quality of the driving image will indeed be affected. Therefore, when the image clarity is poor, the image quality module 10 will decrease the image quality value. In implementations, the image quality module 10 will generate an image quality value based on the exposure concentration and the image clarity.

In Step 200, the lane line confidence module 11 generates a lane line feature point distribution by detecting a lane line feature point set of a plurality of driving images captured by a plurality of image capturing modules 6 and analyzes lane continuity and lane line features based on the lane line feature point distribution to generate the lane line confidence. In a preferred embodiment, the lane line confidence module 11 detects a plurality of driving images, such as performing second-order image processing (e.g., Sobel or Canny edge detection image processing) to detect a lane line feature point set. Then, a lane line feature point distribution is generated based on the lane line feature point set. Lane continuity and lane line features are analyzed based on the lane line feature point distribution.

The lane continuity is not used to simply determine whether the lane lines are continuous (some lane lines are drawn as dotted lines, and thus they are not always continuous). The lane continuity is used to determine whether the vehicle 2 can accurately remain to travel in the desired direction of the vehicle 2 along the lane determined by the lane line confidence module 11 based on the lane line feature point distribution.

When the lane line confidence module 11 analyzes that the lane continuity is high, it means that the lane determined by the lane line confidence module 11 based on the lane line feature point distribution is a lane that the vehicle 2 can rely on highly. The vehicle 2 remains to travel in the desired traveling direction.

When the lane line confidence module 11 analyzes that the lane continuity is low, it means that the lane determined by the lane line confidence module 11 based on the lane line feature point distribution is not a lane that the vehicle 2 can rely on highly. Low lane continuity may mean that the lane line confidence module 11 cannot completely analyze the lane along the desired traveling direction of the vehicle 2, such as encountering a very wide intersection with no markings at all. Alternatively, the lane line confidence module 11 analyzes that the lane along the direction in which the vehicle 2 intends to travel is unclear or doubtful. For example, the lane line is severely worn, such that the lane line confidence module 11 cannot accurately determine the lane.

In addition, in Step 200, the lane line confidence module 11 can also analyze lane line features, where the lane line features include the lane line features of all lanes around the vehicle 2. After the lane line confidence module 11 analyzes the lane line features, the lane line features will be transmitted to the positioning adjusting module 15 for use.

In Step 500, the weight adjusting module 14 adjusts the driving image weight value, the positioning data weight value, and the inertial data weight value based on the image confidence and the positioning confidence. When the weight adjusting module 14 adjusts the weight value, the driving image weight value+the positioning data weight value+the inertial data weight value=100%.

When the image confidence is greater than or equal to an image confidence threshold value, the weight adjusting module 14 adjusts the driving image weight value to 100%, and adjusts the positioning data weight value and inertial data weight value to 0 (at this time, one can position the coordinates of the vehicle 2 based on the information of the plurality of driving images captured by the plurality of image capturing modules 6).

When the image confidence is less than the image confidence threshold value and the positioning confidence is greater than or equal to a positioning confidence threshold value, the weight adjusting module 14 adjusts the driving image weight value to less than 100%, and adjusts the positioning data weight value and the inertial data weight value to greater than 0 and less than the driving image weight value (at this time, the coordinates of the vehicle 2 are not positioned merely based on the information of the plurality of driving images captured by the plurality of image capturing modules 6. The coordinates of the vehicle 2 are positioned based on the information of a plurality of driving images, a plurality of positioning data received by the positioning sensing module 7, and inertial measurement data measured by an inertial measurement module 5 arranged on the vehicle 2 combined with an original positioning coordinate value obtained by the vehicle positioning system 1).

When the image confidence is less than the image confidence threshold value and the positioning confidence is less than the positioning confidence threshold value, the weight adjusting module 14 adjusts the driving image weight value to less than 100%, adjusts the positioning data weight value to 0, and adjusts the inertial data weight value to greater than 0 and less than the driving image weight value (at this time, the coordinates of the vehicle 2 are not positioned merely based on the information of the plurality of driving images captured by the plurality of image capturing modules 6. The coordinates of the vehicle 2 do not completely depend on a plurality of positioning data received by a positioning sensing module 7. As a result, the coordinates of the vehicle 2 are positioned based on the information of a plurality of driving images and inertial measurement data measured by an inertial measurement module 5 arranged on the vehicle 2 combined with an original positioning coordinate value obtained by the vehicle positioning system 1).

In Step 600, the positioning adjusting module 15 adjusts the original positioning coordinate value obtained by the vehicle positioning system 1 based on the driving image weight value, the positioning data weight value, and the inertial data weight value to generate the final positioning coordinate value. Step 600 includes the following steps:
(1) by the positioning adjusting module, matching the lane line features with a vector map to generate a driving image coordinate value, wherein the lane line features are analyzed by the lane line confidence module 11, and the vector map is pre-stored in a storage module 16. Alternatively, after the vector map is obtained from a mapping module 40 arranged in a cloud through a wireless receiving module 8 arranged on the vehicle 2, the vector map is stored in the storage module 16 and the storage module 16 transmits the vector map to the positioning adjusting module 15.
(2) when the positioning data weight value is not equal to 0, the positioning adjusting module 15 generates a positioning data coordinate value based on the plurality of positioning data received by the positioning sensing module 7;
(3) when the inertial data weight value is not equal to 0, the positioning adjusting module 15 generates an inertial data coordinate value based on the original positioning coordinate value obtained by the vehicle positioning system 1 and inertial measurement data measured by an inertial measurement module 5 arranged on the vehicle 2; and
(4) by the positioning adjusting module 15, generating the final positioning coordinate value, wherein the final positioning coordinate value=[(the driving image coordinate value×the driving image weight value)+(the positioning data coordinate value×the positioning data weight value)+(the inertial data coordinate value×the inertial data weight value) and the inertial data weight value=(100%−¿the driving image weight value−¿the positioning data weight value)].

The driving image coordinate value is the coordinate value of the vehicle 2 that is obtained when the vehicle 2 is positioned merely based on the information of the plurality of driving images captured by the plurality of image capturing modules 6 (Since the lane line features analyzed by the lane line confidence module 11 include lane line features of all lanes around the vehicle 2, the positioning adjusting module 15 matches the vector map with the lane line features of all these lanes to find the location of the vehicle 2 in the vector map and generate the driving image coordinate value. That is to say, the driving image coordinate value is the coordinate value of the vehicle 2 that is obtained when the vehicle 2 is positioned merely based on the information of the plurality of driving images captured by the plurality of image capturing modules 6). The positioning data coordinate value is the coordinate value of the vehicle 2 that is obtained when the vehicle 2 is positioned merely based on the plurality of positioning data received by the positioning sensing module 7. The inertial data coordinate value is the coordinate value of the vehicle 2 that is obtained when the vehicle 2 positioned merely based on the original positioning coordinate value combined with the inertial measurement data measured by the inertial measurement module 5. The driving image weight value, the positioning data weight value, and the inertial data weight value combined with positioning data and inertial data for temporary reinforcement are adjusted when driving images are abnormal. This can eliminate the need to use high-priced optical radar and avoid over-reliance on driving images that may cause failure or abnormality of positioning determination.

In Step 600, when the vehicle positioning system 1 never obtains the original positioning coordinate value (i.e., when the vehicle positioning system 1 of the present invention initially performs the vehicle positioning method of the present invention), the vehicle positioning system 1 initially obtains the original positioning coordinate value by performing following steps:

by the positioning adjusting module 15, matching the lane line features with a vector map to generate a driving image coordinate value, wherein the lane line features are analyzed by the lane line confidence module 11, the vector map may be pre-stored in a storage module 16, and the vector map is alternatively stored in the storage module 16 after the vector map is obtained from a mapping module 40 arranged in a cloud 4 through a wireless receiving module 8 arranged on the vehicle 2; and

by the positioning adjusting module 15, copying the generated driving image coordinate value to the original positioning coordinate value, so that the vehicle positioning system 1 initially obtains the original positioning coordinate value, wherein the step of using the vehicle positioning system 1 to initially obtain the original positioning coordinate value is performed when the coordinate value of the vehicle 2 is positioned merely based on the information of the plurality of driving images captured by the plurality of image capturing modules 6.

When Step 600 is performed, the vehicle positioning system 1 has obtained the original positioning coordinate value (i.e., when the vehicle positioning system 1 of the present invention does not initially perform the vehicle positioning method of the present invention). After Step 600, the vehicle positioning method of the invention further includes the following step: the positioning adjusting module 15 copies the final positioning coordinate value generated by presently performing the vehicle positioning method of the present invention to the original positioning coordinate value. Therefore, the vehicle positioning system 1 performs the vehicle positioning method of the present invention next time to obtain the original positioning coordinate value that is the final positioning coordinate value generated by the positioning adjusting module 15 when the vehicle positioning method of the present invention is performed this time.

In a preferred embodiment, the inertial measurement module 8 of the present invention includes an accelerometer in three directions and a gyroscope in three axes. For example, the three directions of the accelerometers include a right direction, a front direction, and an up direction. The three axes of the gyroscope are respectively arranged along a right direction, a front direction, and an up direction. The inertial measurement module 8 is used to measure inertial measurement data, where the inertial measurement data includes acceleration in three directions and three-axis attitude angles.

When the vehicle positioning method of the present invention is previously performed, the vehicle 2 is located at the final positioning coordinate value generated by the positioning adjusting module 15 at that time. After a time interval (the time interval is a time difference between a time point when the vehicle positioning method of the present invention is previously performed and a time point when the vehicle positioning method of the present invention is presently performed), the vehicle 2 drives from the original positioning coordinate value (i.e., the final positioning coordinate value generated by the positioning adjusting module 15 when the vehicle positioning method of the present invention is previously performed) to an inertial data coordinate value (i.e., the coordinate value of the vehicle 2 is obtained when the vehicle 2 is positioned merely based on the original positioning coordinate value obtained by the vehicle positioning system 1 combined with the inertial measurement data measured by the inertial measurement module 5). Based on the acceleration in three directions and the three-axis attitude angle of the inertial measurement data and the original positioning coordinate value obtained by the vehicle positioning system 1 (i.e., the final positioning coordinate value is generated by the positioning adjusting module 15 when the vehicle positioning method of the present invention is previously performed), the positioning adjusting module 15 calculates that the vehicle 2 will drive from the original positioning coordinate value to the inertial data coordinate value after the time interval (the time interval is a time difference between a time point when the vehicle positioning method of the present invention is previously performed and a time point when the vehicle positioning method of the present invention is presently performed).

In other embodiments, the inertial measurement module 8 of the present invention includes an accelerometer in three directions, a three-axis gyroscope, and three magnetometers, where the inertial measurement module 8 measures the inertial measurement data that include acceleration in three directions, three-axis attitude angles, and a magnetic field strength, a magnetic inclination angle, and a magnetic declination angle in each of the three axes.

In Step 600, when the image confidence remains less than an image confidence threshold value and the positioning confidence remains greater than or equal to a positioning confidence threshold value within a first time interval, the positioning adjusting module 15 generates a warning signal to warn the driver of the vehicle 2. Within the first time interval, the vehicle positioning system 1 positions the coordinate value of the vehicle 2 based on the driving image coordinate value, the positioning data coordinate value, and the inertial data coordinate value. At this time, one needs to pay careful attention to the state of vehicle 2. When the image confidence is greater than or equal to the image confidence threshold value or the positioning confidence is less than the positioning confidence threshold value, the positioning adjusting module 15 stops generating the warning signal.

In Step 600, when the image confidence remains less than an image confidence threshold value and the positioning confidence remains less than a positioning confidence threshold value within a second time interval, the positioning adjusting module 15 remains to generate a positioning failure signal to warn the driver of vehicle 2. Before the driver manually drives vehicle 2, the final positioning coordinate value remains to be generated. Within the second time interval, the vehicle positioning system 1 positions the coordinate value of the vehicle 2 based on the driving image coordinate value and the inertial data coordinate value. At this time, the driver needs to manually drive the vehicle 2. When the image confidence is greater than or equal to the image confidence threshold value or the positioning confidence is greater than or equal to the positioning confidence threshold value, the positioning adjusting module 15 stops remaining to generate the positioning failure signals.

In a preferred embodiment, the positioning sensing module 7 is a satellite positioning sensing module. The satellite positioning sensing module is used to receive a plurality of satellite positioning data transmitted by a plurality of satellites of a global navigation satellite system (GNSS) 3. In Step 400, the plurality of positioning data received by the positioning sensing module 7 includes a plurality of satellite positioning data, wherein the plurality of satellite positioning data respectively correspond to the plurality of positioning data. The positioning confidence module 13 generates a dilution of precision based on the plurality of satellite positioning data received by the positioning sensing module 7 and then generates a positioning confidence based on the dilution of precision.

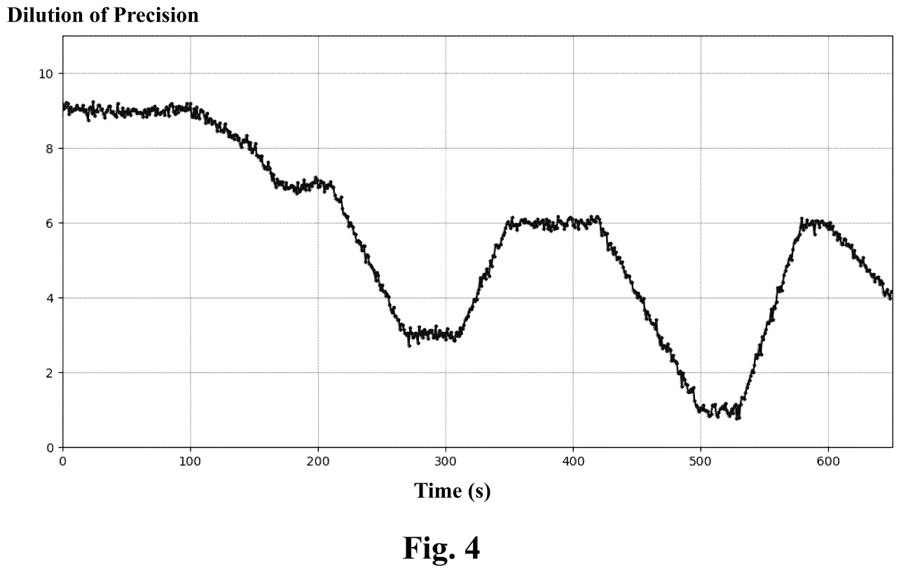

Please also refer to FIG. 4, which is a schematic diagram illustrating the variation of a dilution of precision of the present invention over time. FIG. 4 shows that the dilution of precision changes dynamically with time. When the dilution of precision is higher, it means that the relative positions between satellites are closer and the positioning accuracy is lower. When the dilution of precision is lower, it means that the relative positions between satellites are more dispersed and the positioning accuracy is higher. For example, when the dilution of precision is greater than 6, the positioning accuracy is low. When the dilution of precision is less than 1, the positioning accuracy is high. The dilution of precision is at least related to the number of positioning satellites, the distribution positions of the positioning satellites relative to the vehicle 2, the distances of the positioning satellites relative to the vehicle 2, the existence or inexistence of obstacles between the positioning satellites and the vehicle. 2, weather, etc.

In some embodiments, the image confidence module 12 can adjust an image quality weight value and a lane line confidence weight value, where the image confidence generated by the image confidence module 12=(image quality value×image quality weight value)+(lane line confidence×lane line confidence weight value). (image quality weight value+lane line confidence weight value)=100%. When the image quality value is high and the lane line confidence is high, the image confidence generated by the image confidence module 12 is high. When the image quality value is low and the lane line confidence is low, the image confidence generated by the image confidence module 12 is low. When the image quality value is low and the lane line confidence is high, or when the image quality value is high and the lane line confidence is low, the image confidence generated by the image confidence module 12 is calculated based on the image quality weight value and the lane line confidence weight value.

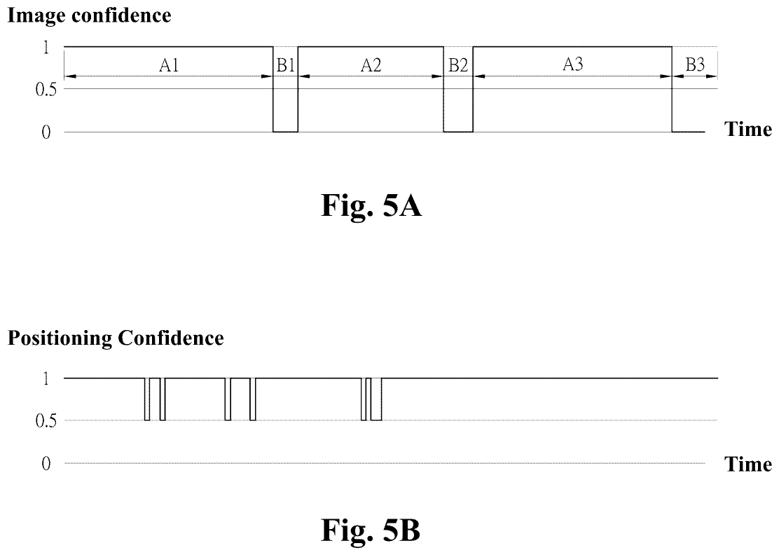

Please refer to FIG. 5A and FIG. 5B. FIGS. 5A and 5B are respectively schematic diagrams illustrating the variations of an image confidence and a positioning confidence of the present invention over time when a vehicle drives on a flat road. In the embodiment, the positioning sensing module 7 is a satellite positioning sensing module. The time axes in FIG. 5A and FIG. 5B are identical and corresponding. Steps 100, 200, and 300 of the vehicle positioning method of the present invention are respectively performed by the vehicle positioning system 1 of the present invention to obtain FIG. 5A that is a schematic diagram illustrating the variation of an image confidence over time. Wherein, the image confidence is set to be greater than or equal to 0 and less than or equal to 1. The image confidence threshold value is set to 0.5. Step 400 of the vehicle positioning method of the present invention is performed to obtain FIG. 5B that is a schematic diagram illustrating the variation of a positioning confidence over time. The positioning confidence is set to be greater than or equal to 0 and less than or equal to 1 and the positioning confidence threshold value is set to 0.5.

In time intervals A1, A2, and A3 of FIG. 5A and FIG. 5B, the vehicle 2 drives on a road with clear and good markings. In time intervals B1, B2, and B3, the vehicle 2 drives to a large intersection. When the vehicle 2 drives in time interval A1, the road markings are clear and good and the image confidence is 1 (greater than the image confidence threshold value of 0.5). Therefore, in Step 500, the weight adjusting module 14 adjusts the driving image weight value to 100% and adjusts the positioning data weight value and the inertial data weight value to 0 respectively. At this time, one can position the coordinate value of the vehicle 2 merely based on the information of the plurality of driving images captured by the plurality of image capturing modules 6. In Step 600, the positioning adjusting module 15 generates the final positioning coordinate value=(driving image coordinate value×100%) based on the driving image weight value, the positioning data weight value, and the inertial data weight value.

When the vehicle 2 drives in time interval B1, the vehicle 2 encounters a large intersection. Thus, the lane line confidence module 11 decreases the lane line confidence, resulting in an image confidence of 0 (less than the image confidence threshold value of 0.5). However, since the positioning sensing module 7 receives signals well and the dilution of precision is high, the positioning confidence is 1 (greater than the positioning confidence threshold value of 0.5). Therefore, in Step 500, the weight adjusting module 14 adjusts the driving image weight value to less than 100% (e.g., the driving image weight value is adjusted to 80%) and adjusts the positioning data weight value and the inertial data weight value to greater than 0 and less than the driving image weight value (e.g., the positioning data weight value and the inertial data weight value are adjusted to 10% respectively). At this time, it is not possible to position the coordinate value of the vehicle 2 merely based on the information of the plurality of driving images captured by the plurality of image capturing modules 6. Instead, it is necessary to position the coordinate value of the vehicle 2 based on the information of the plurality of driving images, the plurality of positioning data received by the positioning sensing module 7, and the inertial measurement data measured by the inertial measurement module 5 combined with the original positioning coordinate value obtained by the vehicle positioning system 1. In Step 600, the positioning adjusting module 15 adjusts the original positioning coordinate value based on the driving image weight value, the positioning data weight value, and the inertial data weight value to generate the final positioning coordinate value=((driving image coordinate value×80%)+(positioning data coordinate value×10%)+(inertial data coordinate value×10%)).

When the vehicle 2 drives in time intervals A2 and A3, the image confidence is 1 (there is no need to consider the image confidence at this time). Therefore, the driving situation in time intervals A2 and A3 is the same as the driving situation in time interval A1. When the vehicle 2 drives in time intervals B2 and B3, the image confidence is 0 and the positioning confidence is 1. Therefore, the driving situation in time intervals B2 and B3 is the same as the driving situation in time interval B1.

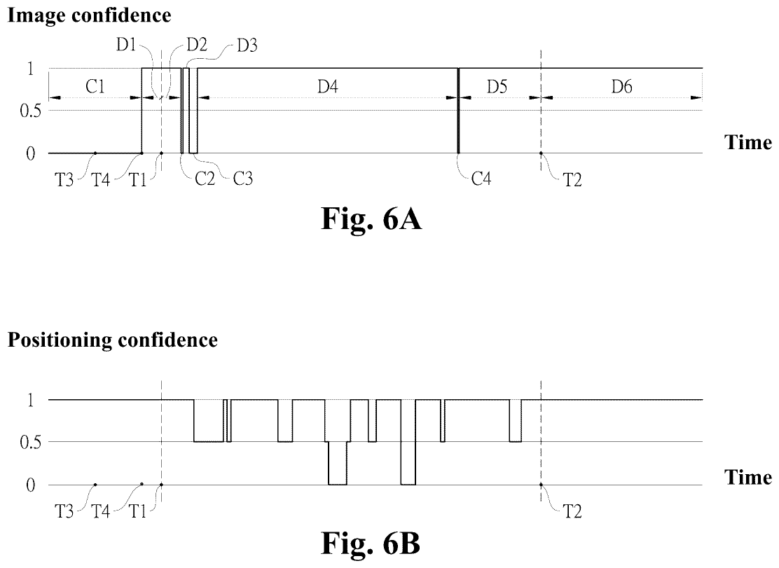

Please refer to FIG. 6A and FIG. 6B. FIGS. 6A and 6B are respectively schematic diagrams illustrating the variations of an image confidence and a positioning confidence of the present invention over time when a vehicle drives at a multi-fork intersection and under a viaduct. In the embodiment, the positioning sensing module 7 is a satellite positioning sensing module. The time axes in FIG. 6A and FIG. 6B are identical and corresponding. The step of obtaining the schematic diagram of the variation of the image confidence over time, the setting range of the image confidence, and the image confidence threshold value to be set of FIG. 6A are all the same as those of FIG. 5A. The step of obtaining the schematic diagram of the variation of the positioning confidence over time, the setting range of the positioning confidence, and the positioning confidence threshold value to be set of FIG. 6B are all the same as those of FIG. 5B.

In the embodiments of FIG. 6A and FIG. 6B, during a time period between 0 and T1 and a time period after T2 in the time axis, the vehicle 2 drives on a flat road and the satellite signal is good at this time. In a time period between T1 and T2 in the time axis, the vehicle 2 drives under the viaduct and the satellite signal is often interfered with the viaduct. In time interval C1, the vehicle 2 drives on a flat road and encounters a multi-fork intersection. In time intervals C2, C3, and C4, the vehicle 2 drives under the viaduct and some lane lines are covered by shadows or partially worn. In time intervals D1 and D6, the vehicle 2 drives on a flat road and the markings are clear and good. In time intervals D2, D3, D4, and D5, the vehicle 2 drives under the viaduct and the markings are clear and good.

When the vehicle 2 drives in time interval C1 and encounters a multi-fork intersection, the lane line confidence module 11 decreases the lane line confidence, causing the image confidence to be 0 (less than the image confidence threshold value of 0.5). However, since the positioning sensing module 7 receives signals well and the dilution of precision is high, the positioning confidence is 1 (greater than the positioning confidence threshold value of 0.5). Therefore, in Step 500, the weight adjusting module 14 will adjust the driving image weight value to less than 100% (e.g., the driving image weight value is adjusted to 70%), and adjust the positioning data weight value and inertial data weight value to greater than 0 and less than the driving image weight value (e.g., the positioning data weight value is adjusted to 20% and the inertial data weight value is adjusted to 10%). At this time, it is not possible to position the coordinate value of the vehicle 2 merely based on the information of the plurality of driving images captured by the plurality of image capturing modules 6. Instead, the coordinate value of the vehicle 2 is positioned based on the information of a plurality of driving images, the plurality of positioning data received by the positioning sensing module 7, and the inertial measurement data measured by the inertial measurement module 5 combined with the original positioning coordinate value obtained by the vehicle positioning system 1.

In Step 600, the positioning adjusting module 15 adjusts the original positioning coordinate value based on the driving image weight value, the positioning data weight value, and the inertial data weight value and generates the final positioning coordinate value=((driving image coordinate value×70%)+(positioning data coordinate value×20%)+(inertial data coordinate value×10%)). However, since time interval C1 when the multi-fork intersection is encountered is longer, the vehicle 2 drives in time interval C1 (=(T4−¿0)) that exceeds a first time interval (=(T3−¿0)) that is preset. Therefore, when the vehicle 2 drives at a time point T3, the positioning adjusting module 15 immediately generates a warning signal to warn the driver that the vehicle positioning system 1 positions the coordinate value of the vehicle 2 based on the driving image coordinate value, the positioning data coordinate value, and the inertial data coordinate value. At this time, one needs to pay careful attention to the state of the vehicle 2.

When the vehicle 2 drives in time interval D1, the road markings are clear and good and the image confidence is 1 (greater than the image confidence threshold value of 0.5). Therefore, in Step 500, the weight adjusting module 14 adjusts the driving image weight value to 100% and adjusts the positioning data weight value and the inertial data weight value to 0 respectively. At this time, one can position the coordinate value of the vehicle 2 based on the information of the plurality of driving images captured by the plurality of image capturing modules 6. In Step 600, since the coordinate value of the vehicle 2 is positioned based on the information of the plurality of driving images captured by the plurality of image capturing modules 6, the positioning adjusting module 15 stops generating the warning signal and then generates the final positioning coordinate value=(driving image coordinate value×100%) based on the driving image weight value, the positioning data weight value, and the inertial data weight value.

When the vehicle 2 drives in time intervals C2, C3, and C4, the image

confidence is 0 and the positioning confidence is greater than or equal to the positioning confidence threshold value of 0.5. Thus, the driving situation in time intervals C2, C3, and C4 is roughly the same as the driving situation in time interval C1. However, the vehicle 2 drives in time intervals C2, C3, and C4 that do not exceed the first time interval (=(T3−¿0)). As a result, the positioning adjusting module 15 does not generate a warning signal. When the vehicle 2 drives in time intervals D2, D3, D4, D5, and D6, the image confidence is 1 (there is no need to consider the image confidence at this time). Therefore, the driving situation in time intervals D2, D3, D4, D5, and D6 is roughly the same as the driving situation in time interval D1. However, since the warning signal is not generated before the vehicle 2 drives in time intervals D2, D3, D4, D5, and D6, the positioning adjusting module 15 will not stop generating the warning signal.

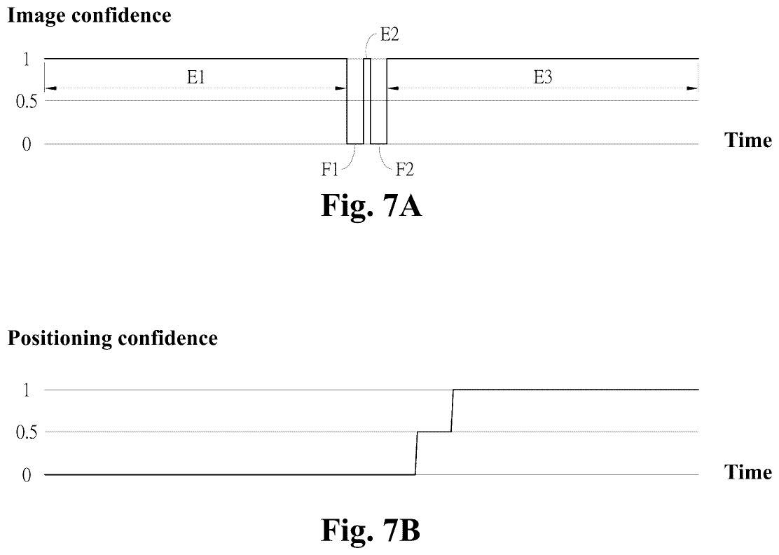

Please refer to FIG. 7A and FIG. 7B. FIGS. 7A and 7B are respectively schematic diagrams illustrating the variations of an image confidence and a positioning confidence of the present invention over time when a vehicle drives out of the entrance of a tunnel. In the embodiment, the positioning sensing module 7 is a satellite positioning sensing module. The time axes in FIG. 7A and FIG. 7B are identical and corresponding. The step of obtaining the schematic diagram of the variation of the image confidence over time, the setting range of the image confidence, and the image confidence threshold value to be set of FIG. 7A are all the same as those of FIG. 5A. The step of obtaining the schematic diagram of the variation of the positioning confidence over time, the setting range of the positioning confidence, and the positioning confidence threshold value to be set of FIG. 7B are the same as those in FIG. 5B.

In time interval E1 of the embodiment of FIG. 7A and FIG. 7B, the vehicle 2 drives in the tunnel. In time intervals F1, E2, and F2, the vehicle 2 drives near the entrance of the tunnel. In time interval E3, the vehicle 2 has just exited the entrance of the tunnel. When the vehicle 2 drives in time interval E1, the illumination in the tunnel is good, the road markings are clear and good, and the image confidence is 1 (greater than the image confidence threshold value of 0.5) at this time. Therefore, in Step 500, the weight adjusting module 14 adjusts the driving image weight value to 100% and adjusts the positioning data weight value and the inertial data weight value to 0 respectively. At this time, one can position the coordinate value of the vehicle 2 merely based on the information of the plurality of driving images captured by the plurality of image capturing modules 6. In Step 600, the positioning adjusting module 15 generates the final positioning coordinate value=(driving image coordinate value×100%) based on the driving image weight value, the positioning data weight value, and the inertial data weight value.

When the vehicle 2 drives in time interval F1 (just arriving at the entrance of the tunnel), there is sufficient sunlight outside the tunnel. In contrast, the light inside the tunnel is very dark, causing the captured driving image to be overexposed within a short period of time (the exposure concentration is obviously concentrated in the bright area). Thus, after the lane line confidence module 11 decreases the lane line confidence, the image confidence is 0 (less than the image confidence threshold value of 0.5). At this time, because the vehicle 2 has not yet completely exited the tunnel, the positioning sensing module 7 has poor signal reception, resulting in a low dilution of precision. Thus, the positioning confidence is 0 (and less than the positioning confidence threshold value of 0.5). Therefore, in Step 500, the weight adjusting module 14 adjusts the driving image weight value to less than 100% (e.g., the driving image weight value is adjusted to 80%), adjusts the positioning data weight value to 0, and adjusts the inertial data weight value to greater than 0 and less than the driving image weight value (e.g., the inertial data weight value is adjusted to 20%). At this time, it is impossible to position the coordinate value of the vehicle 2 merely based on the information of the plurality of driving images captured by the plurality of image capturing modules 6. The coordinate value of the vehicle 2 is not positioned based on the plurality of positioning data received by the positioning sensing module 7. Accordingly, the coordinate value of the vehicle 2 is positioned based on the information of the plurality of driving images and the inertial measurement data measured by the inertial measurement module 5 on the vehicle 2 combined with the original positioning coordinate value obtained by the vehicle positioning system 1. In Step 600, the positioning adjusting module 15 adjusts the original positioning coordinate value based on the driving image weight value, the positioning data weight value, and the inertial data weight value to generate the final positioning coordinate value=((driving image coordinate value×80%)+(inertial data coordinate value×20%)).

When the vehicle 2 drives in time intervals E2 and E3, the image confidence is 1 (there is no need to consider the image confidence at this time). Therefore, the driving situation in time intervals E2 and E3 is the same as the driving situation in time interval E1. When the vehicle 2 drives

in time interval F2, the image confidence is 0 and the positioning confidence is 0. Therefore, the driving situation in time interval F2 is the same as the driving situation in time interval F1.

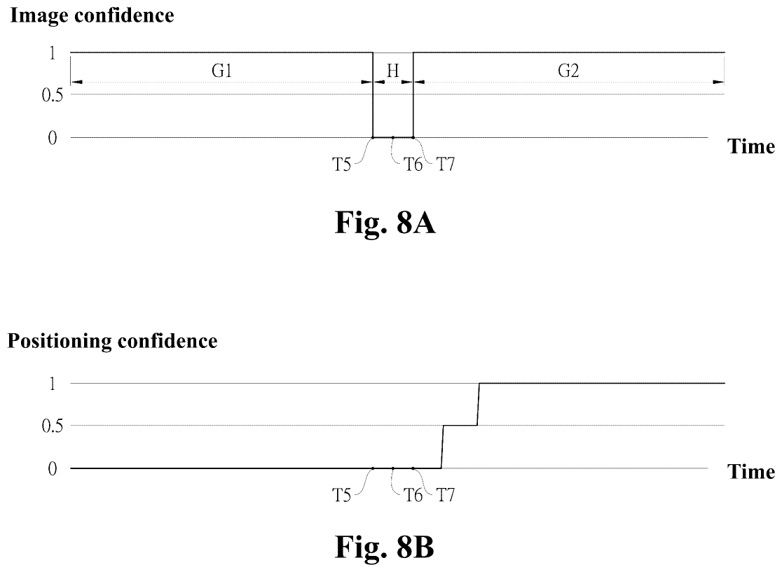

Please refer to FIG. 8A and FIG. 8B. FIGS. 8A and 8B are respectively schematic diagrams illustrating the variations of an image confidence and a positioning confidence of the present invention over time when a vehicle drives out of the entrance of another tunnel. In the embodiment, the positioning sensing module 7 is a satellite positioning sensing module. The time axes in FIG. 8A and FIG. 8B are identical and corresponding. The step of obtaining the schematic diagram of the variation of the image confidence over time, the setting range of the image confidence, and the image confidence threshold value to be set of FIG. 8A are all the same as those of FIG. 5A. The step of obtaining the schematic diagram of the variation of the positioning confidence over time, the setting range of the positioning confidence, and the positioning confidence threshold value to be set of FIG. 8B are the same as those in FIG. 5B.

In time interval G1 of the embodiment of FIG. 8A and FIG. 8B, the vehicle 2 drives in the tunnel. In time interval H, the vehicle 2 drives near the entrance of the tunnel. In time interval G2, the vehicle 2 has just exited the entrance of the tunnel. When the vehicle 2 drives in time interval G1, the illumination in the tunnel is good, the road markings are clear and good, and the image confidence is 1 (greater than the image confidence threshold value of 0.5) at this time. This driving situation in time interval G1 is the same as the driving situation of the vehicle 2 in time interval E1 in the embodiments of FIGS. 7A and 7B. Therefore, details about Steps 500 and 600 must be referred to the description of the vehicle 2 that drives in time interval E1 of the embodiment of FIG. 7A and FIG. 7B.

When the vehicle 2 drives in time interval H (just arriving at the entrance of the tunnel), the exposure concentration is obviously concentrated in the bright area. That is to say, the driving image is overexposed. After the lane line confidence module 11 decreases the lane line confidence, causing the image confidence to be 0 (less than the image confidence threshold value of 0.5). At this time, because the vehicle 2 has not been completely driven out of the tunnel, the positioning sensing module 7 has poor signal reception, resulting in a low precision attenuation factor. Thus, the positioning confidence is 0 (and less than the positioning confidence threshold value of 0.5). The driving situation in time interval H is the same as the driving situation of the vehicle 2 in time interval F1 of the embodiments of FIGS. 7A and 7B. Therefore, details about Steps 500 and 600 must be referred to the description of the vehicle 2 that drives in time interval F1 of the embodiment of FIG. 7A and FIG. 7B.

The vehicle 2 drives in time interval H (=(T7−¿T5)) (i.e., the image confidence is 0 and the positioning confidence is 0) that exceeds a second time interval (=(T6−¿T5)) that is preset. Therefore, when the vehicle 2 drives at a time point T6, the positioning adjusting module 15 remains to generate a positioning failure signal and remains to generate the final positioning coordinate value, thereby warning the driver of the vehicle 2 that the vehicle positioning system 1 positions the coordinate value of the vehicle 2 based on the driving image coordinate value and the inertial data coordinate value. At this time, the driver needs to manually drive the vehicle 2. When the vehicle 2 drives in time interval G2, the image confidence is 1 (there is no need to consider the image confidence at this time), and the positioning adjusting module 15 stops generating the positioning failure signal. Therefore, the driving situation in time interval G2 is the same as the driving situation in time interval G1.

In some embodiments, when the image confidence is less than the image confidence threshold value and the positioning confidence is greater than or equal to the positioning confidence threshold value, the weight adjusting module 14 adjusts the driving image weight value to greater than or equal to 70% and less than or equal to 90%, and adjust the positioning data weight value and the inertial data weight value to greater than or equal to 5% and less than or equal to 15% respectively. In other embodiments, when the image confidence is less than the image confidence threshold value and the positioning confidence is greater than or equal to the positioning confidence threshold value, the weight adjusting module 14 adjusts the driving image weight value to greater than or equal to 60% and less than or equal to 90%, and adjusts the positioning data weight value and the inertial data weight value to greater than or equal to 5% and less than or equal to 20% respectively.

In some embodiments, when the image confidence is less than the image confidence threshold value and the positioning confidence is less than the positioning confidence threshold value, the weight adjusting module 14 adjusts the driving image weight value to greater than or equal to 70% and less than or equal to 90%, and adjusts the inertial data weight value to greater than or equal to 10% and less than or equal to 30%. In other embodiments, when the image confidence is less than the image confidence threshold value and the positioning confidence is less than the positioning confidence threshold value, the weight adjusting module 14 adjusts the driving image weight value to greater than or equal to 65% and less than or equal to 95%, and adjusts the inertial data weight value to greater than or equal to 5% and less than or equal to 35%.

In some embodiments, the vehicle positioning system 1 uses an inertial measurement module 5 with higher measurement accuracy. Thus, the inertial data weight value can be appropriately increased. For example, when the image confidence is less than the image confidence threshold value and the positioning confidence is greater than or equal to the positioning confidence threshold value, the weight adjusting module 14 adjusts the driving image weight value to greater than or equal to 60% and less than or equal to 85%, adjusts the positioning data weight value to greater than or equal to 5% and less than or equal to 10%, and adjusts the inertial data weight value to greater than or equal to 10% and less than or equal to 30%. For another example, when the image confidence is less than the image confidence threshold value and the positioning confidence is less than the positioning confidence threshold value, the weight adjusting module 14 adjusts the driving image weight value to greater than or equal to 60% and less than or equal to 85%, and adjusts the inertial data weight value to greater than or equal to 15% and less than or equal to 40%. In some embodiments, the vehicle positioning system 1 uses an inertial measurement module 5 with higher measurement accuracy. In this case, the first time interval and the second time interval can be appropriately increased.

The foregoing descriptions are the specific embodiments of the present invention and the technical means used. Many changes and modifications can be derived based on the disclosure or teachings of this article, and they can still be regarded as equivalent changes to the concept of the present invention. The changes and modifications that do not exceed the spirit of the description and drawings shall be deemed to be within the technical scope of the present invention and shall be stated in advance.

In conclusion, the vehicle positioning method based on weight adjustment and the system using the same adjust the driving image weight value, the positioning data weight value, and the inertial data weight value combined with positioning data and inertial data for temporary reinforcement when driving images are abnormal. This can eliminate the need to use high-priced optical radar and avoid over-reliance on driving images that may cause failure or abnormality of positioning determination.

The embodiments described above are only to exemplify the present invention but not to limit the scope of the present invention. Therefore, any equivalent modification or variation according to the shapes, structures, features, or spirit disclosed by the present invention is to be also included within the scope of the present invention.

What is claimed is:

1. A vehicle positioning method based on weight adjustment, performed by a positioning system arranged on a vehicle, comprising:
by an image quality module of the positioning system, generating an image quality value based on an exposure concentration of each of a plurality of driving images captured by a plurality of image capturing modules arranged on the vehicle;
by a lane line confidence module of the positioning system, generating a lane line confidence based on the plurality of driving images;
by an image confidence module of the positioning system, generating an image confidence based on the image quality value and the lane line confidence;
by a positioning confidence module of the positioning system, generating a positioning confidence based on a plurality of positioning data received by a positioning sensing module arranged on the vehicle;
by a weight adjusting module of the positioning system, adjusting a driving image weight value, a positioning data weight value, and an inertial data weight value based on the image confidence and the positioning confidence; and
by a positioning adjusting module of the positioning system, adjusting an original positioning coordinate value based on the driving image weight value, the positioning data weight value, and the inertial data weight value to generate a final positioning coordinate value.

2. The vehicle positioning method based on weight adjustment according to claim 1, wherein the image quality module further generates the image quality value based on the exposure concentration and image clarity of each of the plurality of driving images captured by the plurality of image capturing modules.

3. The vehicle positioning method based on weight adjustment according to claim 1, wherein the image quality module decreases the image quality value when the exposure concentration is greater than a first threshold value or less than a second threshold value, the image quality module increases the image quality value when the exposure concentration is less than or equal to the first threshold value and the exposure concentration is greater than or equal to the second threshold value, and the first threshold value is greater than the second threshold value.

4. The vehicle positioning method based on weight adjustment according to claim 1, wherein the plurality of positioning data include a plurality of satellite positioning data that respectively correspond to the plurality of positioning data, and the positioning confidence module generates a dilution of precision based on the plurality of satellite positioning data, and then generates the positioning confidence based on the dilution of precision.

5. The vehicle positioning method based on weight adjustment according to claim 4, wherein the positioning sensing module receives the plurality of satellite positioning data transmitted by a plurality of positioning satellites that respectively correspond to the plurality of satellite positioning data, and the dilution of precision is at least related to number of the plurality of positioning satellites, distribution positions of the plurality of positioning satellites relative to the vehicle, and distances of the plurality of positioning satellites relative to the vehicle.

6. The vehicle positioning method based on weight adjustment according to claim 1, wherein the weight adjusting module adjusts the driving image weight value to 100% and adjusts the positioning data weight value and the inertial data weight value to 0 when the image confidence is greater than or equal to an image confidence threshold value; the weight adjusting module adjusts the driving image weight value to less than 100% and adjusts the positioning data weight value and the inertial data weight value to greater than 0 and less than the driving image weight value when the image confidence is less than an image confidence threshold value and the positioning confidence is greater than or equal to a positioning confidence threshold value; or the weight adjusting module adjusts the driving image weight value to less than 100%, adjusts the positioning data weight value to 0, and adjusts the inertial data weight value to greater than 0 and less than the driving image weight value when the image confidence is less than an image confidence threshold value and the positioning confidence is less than a positioning confidence threshold value.

7. The vehicle positioning method based on weight adjustment according to claim 1, wherein the lane line confidence module detects a lane line feature point set of the plurality of driving images to generate a lane line feature point distribution and analyzes lane continuity and lane line features based on the lane line feature point distribution to generate the lane line confidence.

8. The vehicle positioning method based on weight adjustment according to claim 7, wherein the step of generating the final positioning coordinate value by the positioning adjusting module includes:
by the positioning adjusting module, matching the lane line features with a vector map to generate a driving image coordinate value, wherein the vector map is stored in a storage module of the positioning system or obtained from a mapping module arranged in a cloud through a wireless receiving module arranged on the vehicle;
when the positioning data weight value is not equal to 0, the positioning adjusting module generates a positioning data coordinate value based on the plurality of positioning data;
when the inertial data weight value is not equal to 0, the positioning adjusting module generates an inertial data coordinate value based on the original positioning coordinate value and inertial measurement data measured by an inertial measurement module arranged on the vehicle; and
by the positioning adjusting module, generating the final positioning coordinate value, wherein the final positioning coordinate value=[(the driving image coordinate value×the driving image weight value)+(the positioning data coordinate value×the positioning data weight value)+(the inertial data coordinate value×the inertial data weight value) and the inertial data weight value=(100%−¿the driving image weight value−¿the positioning data weight value)].

9. The vehicle positioning method based on weight adjustment according to claim 7, wherein when the positioning system never obtains the original positioning coordinate value, the positioning system initially obtains the original positioning coordinate value by performing following steps:
by the positioning adjusting module, matching the lane line features with a vector map to generate a driving image coordinate value, wherein the vector map is stored in a storage module of the positioning system or obtained from a mapping module arranged in a cloud through a wireless receiving module arranged on the vehicle; and
by the positioning adjusting module, copying a generated the driving image coordinate value to the original positioning coordinate value, so that the positioning system obtains the original positioning coordinate value having the driving image coordinate value.

10. The vehicle positioning method based on weight adjustment according to claim 1, wherein when the positioning system has obtained the original positioning coordinate value by previously performing the vehicle positioning method, the positioning adjusting module copies the final positioning coordinate value generated by presently performing the vehicle positioning method to the original positioning coordinate value.

11. The vehicle positioning method based on weight adjustment according to claim 1, wherein the positioning adjusting module remains to generate a positioning failure signal and the final positioning coordinate value when the image confidence remains less than an image confidence threshold value and the positioning confidence remains less than a positioning confidence threshold value within a time interval; and the positioning adjusting module stops remaining to generate the positioning failure signal when the image confidence is greater than or equal to the image confidence threshold value or the positioning confidence is greater than or equal to the positioning confidence threshold value.

12. A vehicle positioning system based on weight adjustment, arranged on a vehicle, the vehicle positioning system comprising:
an image quality module configured to generate an image quality value based on an exposure concentration of each of a plurality of driving images captured by a plurality of image capturing modules arranged on the vehicle;
a lane line confidence module configured to generate a lane line confidence based on the plurality of driving images;
an image confidence module configured to generate an image confidence based on the image quality value and the lane line confidence;
a positioning confidence module configured to generate a positioning confidence based on a plurality of positioning data received by a positioning sensing module arranged on the vehicle;
a weight adjusting module configured to adjust a driving image weight value, a positioning data weight value, and an inertial data weight value based on the image confidence and the positioning confidence; and
a positioning adjusting module configured to adjust an original positioning coordinate value obtained by the positioning system based on the driving image weight value, the positioning data weight value, and the inertial data weight value to generate a final positioning coordinate value.

13. The vehicle positioning system based on weight adjustment according to claim 12, wherein the image quality module further generates the image quality value based on the exposure concentration and image clarity of each of the plurality of driving images captured by the plurality of image capturing modules.

14. The vehicle positioning system based on weight adjustment according to claim 12, wherein the image quality module decreases the image quality value when the exposure concentration is greater than a first threshold value or less than a second threshold value, the image quality module increases the image quality value when the exposure concentration is less than or equal to the first threshold value and the exposure concentration is greater than or equal to the second threshold value, and the first threshold value is greater than the second threshold value.

15. The vehicle positioning system based on weight adjustment according to claim 12, wherein the plurality of positioning data include a plurality of satellite positioning data that respectively correspond to the plurality of positioning data, and the positioning confidence module generates a dilution of precision based on the plurality of satellite positioning data, and then generates the positioning confidence based on the dilution of precision.

16. The vehicle positioning system based on weight adjustment according to claim 15, wherein the positioning sensing module receives the plurality of satellite positioning data transmitted by a plurality of positioning satellites that respectively correspond to the plurality of satellite positioning data, and the dilution of precision is at least related to number of the plurality of positioning satellites, distribution positions of the plurality of positioning satellites relative to the vehicle, and distances of the plurality of positioning satellites relative to the vehicle.

17. The vehicle positioning system based on weight adjustment according to claim 12, wherein the weight adjusting module adjusts the driving image weight value to 100% and adjusts the positioning data weight value and the inertial data weight value to 0 when the image confidence is greater than or equal to an image confidence threshold value; the weight adjusting module adjusts the driving image weight value to less than 100% and adjusts the positioning data weight value and the inertial data weight value to greater than 0 and less than the driving image weight value when the image confidence is less than an image confidence threshold value and the positioning confidence is greater than or equal to a positioning confidence threshold value; or the weight adjusting module adjusts the driving image weight value to less than 100%, adjusts the positioning data weight value to 0, and adjusts the inertial data weight value to greater than 0 and less than the driving image weight value when the image confidence is less than an image confidence threshold value and the positioning confidence is less than a positioning confidence threshold value.

18. The vehicle positioning system based on weight adjustment according to claim 12, wherein the lane line confidence module is configured to detect a lane line feature point set of the plurality of driving images to generate a lane line feature point distribution and analyze lane continuity and lane line features based on the lane line feature point distribution to generate the lane line confidence.

19. The vehicle positioning system based on weight adjustment according to claim 18, wherein the positioning system further includes a storage module, the positioning adjusting module is configured to match the lane line features with a vector map to generate a driving image coordinate value, wherein the vector map is stored in a storage module of the positioning system or obtained from a mapping module arranged in a cloud through a wireless receiving module arranged on the vehicle; when the positioning data weight value is not equal to 0, the positioning adjusting module generates a positioning data coordinate value based on the plurality of positioning data; when the inertial data weight value is not equal to 0, the positioning adjusting module generates an inertial data coordinate value based on the original positioning coordinate value and inertial measurement data measured by an inertial measurement module arranged on the vehicle; the positioning adjusting module generates the final positioning coordinate value, wherein the final positioning coordinate value=[(the driving image coordinate value×the driving image weight value)+(the positioning data coordinate value×the positioning data weight value)+(the inertial data coordinate value×the inertial data weight value) and the inertial data weight value=(100%−¿the driving image weight value−¿the positioning data weight value)].

20. The vehicle positioning system based on weight adjustment according to claim 12, wherein the positioning adjusting module remains to generate a positioning failure signal and the final positioning coordinate value when the image confidence remains less than an image confidence threshold value and the positioning confidence remains less than a positioning confidence threshold value within a time interval.
